(19) United States
(12) Patent Application Publication
(10) Pub. No.: US 2026/0066478 A1
(43) Pub. Date: Mar. 5, 2026

(54) BATTERY MODULE, VEHICLE, AND BUS BAR

(71) Applicant: KABUSHIKI KAISHA TOSHIBA, Kawasaki-shi (JP)

(72) Inventors: Yohei UEMURA, Tokyo (JP); Sayaka MORIMOTO, Kawasaki (JP); Ryosuke YAGI, Yokohama (JP); Kouki SAKAKIBARA, Tokyo (JP)

(73) Assignee: KABUSHIKI KAISHA TOSHIBA, Kawasaki-shi (JP)

(21) Appl. No.: 19/304,998

(22) Filed: Aug. 20, 2025

(30) Foreign Application Priority Data
Aug. 29, 2024 (JP) 2024-147626

(51) Int. Cl. H01M 50/503; B60K 1/04; B60L 50/64; H01M 50/249; H01M 50/507; H01M 50/509

(52) U.S. Cl. CPC H01M 50/503; H01M 50/249; H01M 50/507; H01M 50/509; B60K 1/04; B60L 50/64; H01M 2220/20

(57) ABSTRACT

A battery module in embodiment includes two cell blocks electrically connected in series and a bus bar, and each of the cell blocks includes a plurality of battery cells electrically connected in parallel. The bus bar forms one or more intra-block connection portions each of which connects two corresponding battery cells belonging to a same cell block to each other for each of the cell blocks, and forms a plurality of inter-block connection portions each of which connects two corresponding battery cells belonging to different cell blocks to each other. In the bus bar, the resistance of each of the intra-block connection portions is higher than the resistance of any of the inter-block connection portions.

### CROSS-REFERENCE TO RELATED APPLICATION

This application is based upon and claims the benefit of priority from Japanese Patent Application No. 2024-147626, filed Aug. 29, 2024; the entire contents of which are incorporated herein by reference.

### FIELD

Embodiments described herein relate generally to a battery module, a vehicle, and a bus bar.

### BACKGROUND

In a battery module, a plurality of battery cells are electrically connected to each other by one or more bus bars. In a certain battery module, for example, in each of a plurality of cell blocks, a plurality of battery cells are electrically connected in parallel to each other, and the plurality of cell blocks are electrically connected in series to each other. In such a battery module, the plurality of battery cells electrically connected to each other are disposed side by side.

In the above-described battery module, even in a case where one of the plurality of battery cells rises to an excessively high temperature due to thermal runaway or the like, it is required to effectively suppress an excessive temperature rise in other battery cells due to heat from the battery cell that has undergone thermal runaway or the like. That is, it is required to effectively suppress the catching fire of the other battery cells due to thermal runaway or the like in a battery cell.

### BRIEF DESCRIPTION OF DRAWINGS

FIG. 1 is a perspective view schematically showing an example of a single battery cell used in a battery module in embodiments and the like.

FIG. 2 is a perspective view schematically showing an example of the configuration of a battery module in embodiments and the like.

FIG. 3 is a schematic diagram showing an example of the configuration of any one of bus bars used in a battery module in embodiments and the like.

FIG. 4 is a schematic diagram showing an example of a configuration in which a plurality of battery cells of two cell blocks are connected to each other by any one of bus bars in a battery module according to embodiments and the like.

FIG. 5 is a schematic diagram showing an example of a circuit model of a battery module according to embodiments and the like.

FIG. 6 is a schematic diagram showing an example of a situation change in a case where thermal runaway occurs in a certain battery cell in a battery module according to embodiments and the like.

FIG. 7 is a schematic diagram showing an example of a circuit model in a case where thermal runaway occurs in a certain battery cell in a battery module according to embodiments and the like.

FIG. 8 is a schematic diagram showing an example of the configuration of any one of bus bars used in a battery module in a certain modification of embodiments and the like.

FIG. 9 is a schematic diagram showing an example of a vehicle in which a battery module according to embodiments and the like is used.

### DETAILED DESCRIPTION

A battery module according to an embodiment includes two cell blocks and a bus bar. Each of the two cell blocks includes a plurality of battery cells electrically connected in parallel to each other, and the two cell blocks are electrically connected in series to each other. The bus bar is integrally formed of a conductive material and connects the plurality of battery cells of the two cell blocks to each other. The bus bar forms one or more intra-block connection portions each of which connects two corresponding battery cells belonging to a same cell block to each other for each of the two cell blocks, and forms a plurality of inter-block connection portions each of which connects two corresponding battery cells belonging to different cell blocks to each other. In the bus bar, the resistance of each of the intra-block connection portions is higher than the resistance of any of the inter-block connection portions.

Hereinafter, embodiments will be described with reference to the drawings. In the embodiments and the like, a battery module including a plurality of battery cells is provided. In the battery module, the plurality of battery cells are electrically connected to each other by one or more bus bars.

### (Battery Cell)

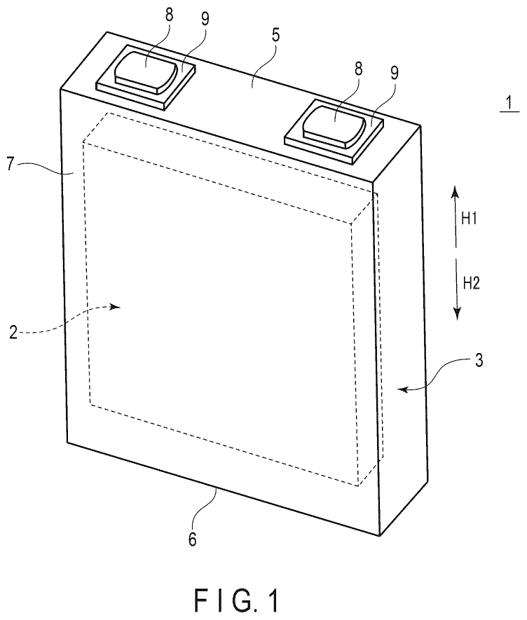

First, the battery cell will be described. In the embodiments and the like, each of the plurality of battery cells used in the battery module has the same configuration as that of any of examples described below. FIG. 1 is a perspective view schematically showing an example of a single battery cell 1 used in a battery module in embodiments and the like. In an example of FIG. 1, the battery cell 1 includes an electrode group 2, an exterior container 3, and a lid member 5. In the battery cell 1, an exterior part is formed by the exterior container 3 and the lid member 5. Each of the exterior container 3 and the lid member 5 is formed of metal, and in an example, is formed of aluminum or an aluminum alloy.

Here, in the battery cell 1, a height direction (a direction indicated by an arrow H1 and an arrow H2) is defined. In the battery cell 1, one side in the height direction is an upper side (an arrow H1 side), and a side opposite to the upper side in the height direction is a lower side (an arrow H2 side). The exterior container 3 includes a bottom wall 6 and a peripheral wall 7, and an internal cavity is defined inside the exterior container 3 by the bottom wall 6 and the peripheral wall 7. In the battery cell 1, the electrode group 2 is housed in the internal cavity of the exterior container 3. In the exterior container 3, the bottom wall 6 covers the internal cavity from the lower side in the height direction. The peripheral wall 7 covers the internal cavity from the outer peripheral side over the entire circumference in the circumferential direction. The peripheral wall 7 is connected to the bottom wall 6 and extends toward the upper side in the height direction from a connection position to the bottom wall 6.

In the exterior container 3, the internal cavity opens to the side opposite to the side where the bottom wall 6 is located in the height direction, that is, to the upper side in the height direction. In the battery cell 1, the lid member 5 is attached to the peripheral wall 7 of the exterior container 3 at the end part on the side opposite to the side where the bottom wall 6 is located. The lid member 5 closes the opening of the internal cavity of the exterior container 3. The lid member 5 is attached to the exterior container 3 by, for example, being welded to the peripheral wall 7.

In the battery cell 1, the electrode group 2 includes a positive electrode and a negative electrode, and in the electrode group 2, the positive electrode and the negative electrode are electrically insulated from each other. In the internal cavity of the exterior container 3, an electrolyte such as an electrolytic solution is held by the electrode group 2. In an example of FIG. 1, a pair of terminals 8 is attached to the lid member 5, and each of the terminals 8 is exposed on the outer surface of the lid member 5. The pair of terminals 8 is disposed apart from each other. In the battery cell 1, one of the pair of terminals 8 serves as a positive electrode terminal, and the other of the pair of terminals 8 serves as a negative electrode terminal.

The positive electrode of the electrode group 2 is electrically connected to the positive electrode terminal via a conductive member such as a lead, and the negative electrode of the electrode group 2 is electrically connected to the negative electrode terminal via a conductive member such as a lead. Each of the terminals 8 is prevented from coming into contact with the lid member 5 by an insulating member 9 or the like, and is electrically insulated from the exterior container 3 and the lid member 5. In the inner cavity of the exterior container 3, the positive electrode and the negative electrode of the electrode group 2 are prevented from coming into contact with the exterior container 3 by the insulating member (not illustrated), and are electrically insulated from the exterior container 3 and the lid member 5.

The configuration of the battery cell is not limited to the configuration of an example of FIG. 1. For example, in an example of FIG. 1, the exterior part is formed of the exterior container 3 and the lid member 5, but the shape and size and the like of the member forming the exterior part can be appropriately changed. The positions and dimensions and the like of the pair of terminals serving as the positive electrode terminal and the negative electrode terminal can also be appropriately changed. (Battery Module)

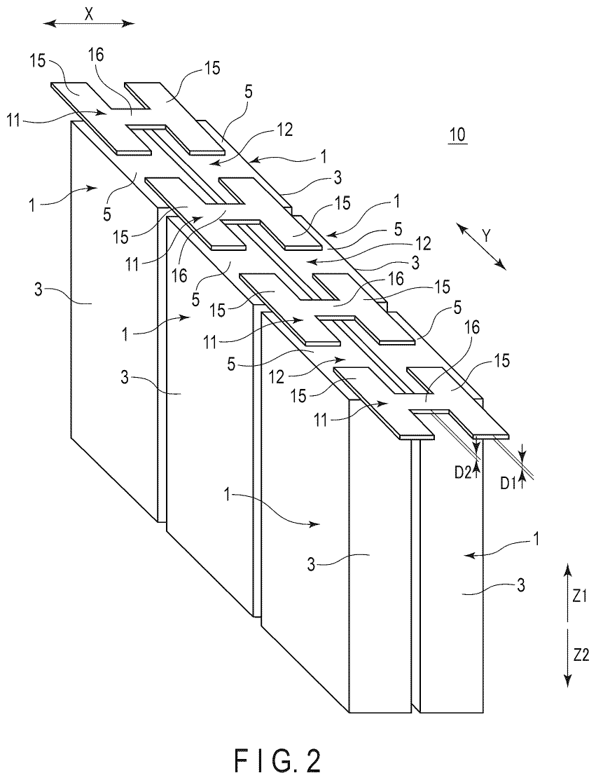

Next, a battery module in which a plurality of battery cells are electrically connected will be described. FIG. 2 is a perspective view schematically showing an example of the configuration of a battery module 10 in embodiments and the like. As shown in FIG. 2, the battery module 10 includes a plurality of battery cells 1, and each of the plurality of battery cells 1 has the same configuration as that of any of the battery cells 1 described above. One or more bus bars 11 are provided in the battery module 10, and the plurality of battery cells 1 are electrically connected via the bus bars 11. Each of the one or more bus bars 11 is integrally formed from a conductive material, for example, integrally formed from aluminum or an aluminum alloy.

In the battery module 10 according to the embodiments and the like, a plurality of cell blocks 12 are formed, and each of the plurality of cell blocks 12 includes a plurality of battery cells 1. In each of the plurality of cell blocks 12, the plurality of battery cells 1 are electrically connected in parallel to each other. In the battery module 10, the plurality of cell blocks 12 are electrically connected to each other in series. In the plurality of cell blocks 12, the parallel number of the battery cells 1 electrically connected to each other is the same. In an example of FIG. 2, two battery cells 1 are electrically connected in parallel to each other in each of the plurality of cell blocks 12, and the parallel number of the battery cells 1 in each of the cell blocks 12 is 2. That is, in the battery module 10, the plurality of cell blocks 12 in each of which battery cells 1 are connected in a two-parallel manner are electrically connected in series to each other.

In the battery module 10 in an example of FIG. 2, a depth direction (a direction indicated by an arrow X), a lateral direction (a direction indicated by an arrow Y) intersecting (orthogonal or substantially orthogonal to) the depth direction, and a height direction (directions indicated by arrows Z1 and Z2) intersecting (orthogonal or substantially orthogonal to) both the depth direction and the lateral direction are defined. The depth direction, the lateral direction, and the height direction are also referred to as an “X direction”, a “Y direction”, and a “Z direction”, respectively. In the battery module 10, one side in the height direction is an upper side (arrow Z1 side), and the side opposite to the upper side in the height direction is a lower side (arrow Z2 side).

In the battery module 10, each of the plurality of battery cells 1 is disposed in a state where the height direction is along the height direction of the battery module 10. Each of the plurality of battery cells 1 is disposed in a state where the upper side in the height direction coincides with or substantially coincides with the upper side in the height direction of the battery module 10, that is, in a state where the outer surface of the lid member 5 faces the upper side in the height direction of the battery module 10.

In the battery module 10, the plurality of cell blocks 12 electrically connected in series are arranged side by side along the lateral direction of the battery module 10. The plurality of cell blocks 12 are disposed without being shifted or almost without being shifted with respect to each other in the depth direction and the height direction of the battery module 10. In each of the cell blocks 12, the plurality of battery cells 1 electrically connected in parallel are arranged side by side along the depth direction of the battery module 10. In each of the plurality of cell blocks 12, the plurality of battery cells 1 are disposed without being shifted or almost without being shifted with respect to each other in the lateral direction and the height direction of the battery module 10.

In the battery module 10 according to the embodiments and the like, the plurality of battery cells 1 of two corresponding cell blocks 12 among the plurality of cell blocks 12 are connected to each other by a bus bar 11. In an example of FIG. 2, the battery cells 1 of two cell blocks 12 adjacent to each other in the arrangement direction (the lateral direction of the battery module 10) of the plurality of cell blocks 12 are connected to each other by a bus bar 11.

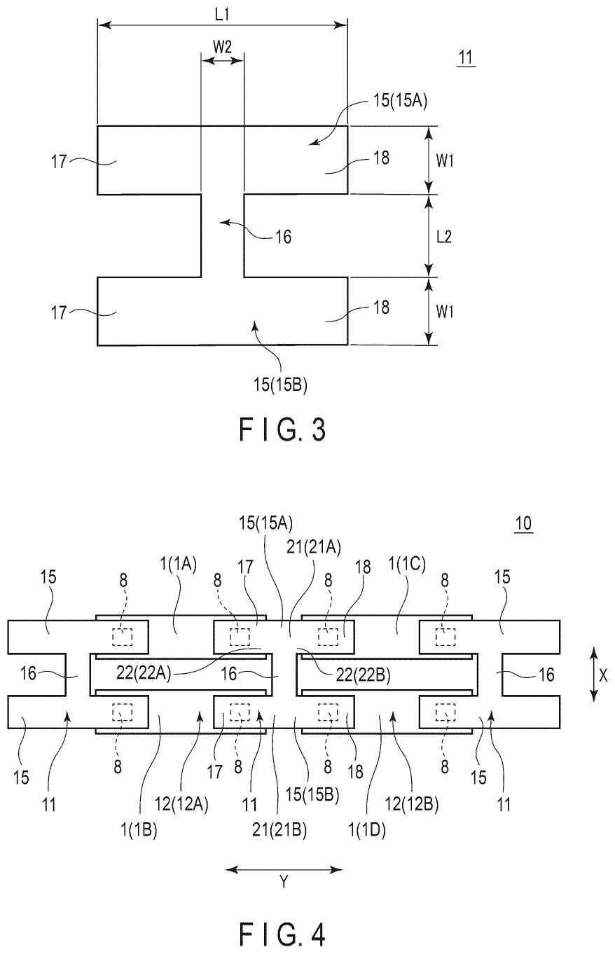

FIG. 3 is a schematic diagram showing an example of the configuration of any one of bus bars 11 used in a battery module 10 in embodiments and the like. FIG. 4 is a schematic diagram showing an example of a configuration in which a plurality of battery cells 1 of two cell blocks 12 are connected to each other by any one of bus bars 11 in a battery module 10 according to embodiments and the like. FIG. 4 shows a state where the battery module 10 is viewed from the upper side in the height direction. Hereinafter, an arbitrary bus bar 11 and connection of the plurality of battery cells 1 of two cell blocks 12 by the bus bar 11 will be described. In the battery module 10, each of the bus bars 11 has a configuration described below, and each of the bus bars 11 connects the plurality of battery cells 1 of two corresponding cell blocks 12 in the same manner as described below.

As shown in FIGS. 3 and 4 and the like, the bus bar 11 includes a plurality of extending plate parts 15 and one or more bridge plate parts 16. The bus bar 11 includes the extending plate parts 15 of the same number as the parallel number of the battery cells 1 in each of the cell blocks 12, and includes two extending plate parts 15A and 15B in an example of FIGS. 3 and 4 and the like. In the bus bar 11, each of the one or more bridge plate parts 16 is bridged between two corresponding ones of the plurality of extending plate parts 15. The bus bar 11 includes the bridge plate parts 16 of the number obtained by subtracting 1 from the parallel number of the battery cells 1 in each of the cell blocks 12. In an example of FIGS. 3 and 4 and the like, the bus bar 11 includes only a bridge plate part 16, and the bridge plate part 16 is bridged between the extending plate parts 15A and 15B.

In each of the plurality of extending plate parts 15 of the bus bar 11, a plate length direction, a plate width direction intersecting (orthogonal or substantially orthogonal to) the plate length direction, and a plate thickness direction intersecting (orthogonal or substantially orthogonal to) both the plate length direction and the plate width direction are defined. In each of the extending plate parts 15, a plate length L1 which is a dimension along the plate length direction, a plate width W1 which is a dimension along the plate width direction, and a plate thickness D1 (see FIG. 2) which is a dimension along the plate thickness direction are defined. In FIGS. 3 and 4, each of the extending plate parts 15 is shown as viewed from one side in the plate thickness direction.

Also in each of one or more bridge plate parts 16, a plate length direction, a plate width direction intersecting (orthogonal or substantially orthogonal to) the plate length direction, and a plate thickness direction intersecting (orthogonal or substantially orthogonal to) both the plate length direction and the plate width direction are defined. Also in each of the bridge plate parts 16, a plate length L2 which is a dimension along the plate length direction, a plate width W2 which is a dimension along the plate width direction, and a plate thickness D2 (see FIG. 2) which is a dimension along the plate thickness direction are defined. In FIGS. 3 and 4, each of the bridge plate parts 16 is shown as viewed from one side in the plate thickness direction.

In the bus bar 11, the plate length direction of each of the extending plate parts 15 coincides or substantially coincides with the plate width direction of each of the bridge plate parts 16, and the plate width direction of each of the extending plate parts 15 coincides or substantially coincides with the plate length direction of each of the bridge plate parts 16. The plate thickness direction of each of the extending plate parts 15 coincides with or substantially coincides with the plate thickness direction of each of the bridge plate parts 16. In an example of FIGS. 3 and 4 and the like, the bus bar 11 has an H shape or a substantially H shape as viewed from the plate thickness direction of the extending plate parts 15A and 15B and the bridge plate part 16.

In the present embodiment, the plate width W2 of each of the bridge plate parts 16 is smaller than the plate width W1 of any of the extending plate parts 15. In the bus bar 11, the plate thickness D1 of the extending plate part 15 and the plate thickness D2 of the bridge plate part 16 coincide or substantially coincide with each other. Therefore, in the bus bar 11, the cross-sectional area of each of the bridge plate parts 16 is smaller than the cross-sectional area of any of the extending plate parts 15, and the resistance per unit length of each of the bridge plate parts 16 is higher than the resistance per unit length of any of the extending plate parts 15.

In an example, as in an example of FIG. 3 and the like, two extending plate parts 15A and 15B and a bridge plate part 16 are formed in the bus bar 11. In each of the extending plate parts 15A and 15B, the plate length L1 is about 60 mm, and the plate width W1 is about 16 mm. In the bridge plate part 16, the plate length L2 is about 8 mm, and the plate width W2 is a value smaller than the plate width W1. The plate thickness of the bus bar 11 corresponding to the plate thickness D1 of each of the extending plate parts 15A and 15B and the plate thickness D2 of the bridge plate part 16 is about 1 mm. In an example, the bus bar 11 is formed of aluminum or an aluminum alloy, and the bus bar 11 has electrical conductivity of about 38 mΩ⁻¹·mm^{31 1}, specific heat of about 900 J·kg⁻¹·K⁻¹, and a density of about 2.7 g·cm⁻³.

In each of the extending plate parts 15, a corresponding one of the bridge plate parts 16 is connected at a central position or a substantially central position in the plate length direction. In each of the extending plate parts 15, two divided regions 17 and 18 divided in the plate length direction with the connection position of the bridge plate part 16 as a boundary are defined. In each of the extending plate parts 15, the divided region (first divided region) 17 corresponds to a region on one side in the plate length direction with respect to the connection position of the bridge plate part 16, and the divided region (second divided region) 18 corresponds to a region on the side opposite to the divided region 17 with respect to the connection position of the bridge plate part 16. In each of the extending plate parts 15, the dimension of the divided region 17 along the plate length direction coincides with or substantially coincides with the dimension of the divided region 18 along the plate length direction.

As shown in FIG. 4 and the like, in the battery module 10, the plate thickness direction of each of the extending plate part 15 and the bridge plate part 16 coincides or substantially coincides with the height direction of the battery module 10, and is along the height direction of each of the plurality of battery cells 1. Each of the plate length direction of the extending plate part 15 and the plate width direction of the bridge plate part 16 coincides or substantially coincides with the lateral direction of the battery module 10, and is along the arrangement direction of the plurality of cell blocks 12. Each of the plate width direction of the extending plate part 15 and the plate length direction of the bridge plate part 16 coincides or substantially coincides with the depth direction of the battery module 10, and is along the arrangement direction of the plurality of battery cells 1 in each of the plurality of cell blocks 12.

Here, two cell blocks 12 electrically connected in series by an arbitrary bus bar 11A are referred to as cell blocks 12A and 12B. The bus bar 11 is connected to a negative electrode terminal of each of the plurality of battery cells 1 constituting the cell block (first cell block) 12A, and is connected to a positive electrode terminal of each of the plurality of battery cells 1 constituting the cell block (second cell block) 12B. As a result, a bus bar 11 electrically connects the two cell blocks 12A and 12B in series, and in each of the cell blocks 12A and 12B, the plurality of battery cells 1 are electrically connected in parallel.

In the bus bar 11, in each of the plurality of extending plate parts 15, one end part in the plate length direction, that is, the divided region 17 is connected to a corresponding one of the plurality of battery cells 1 of the cell block 12A. In the bus bar 11, in each of the plurality of extending plate parts 15, an end part on the side opposite to the side connected to the cell block 12A in the plate length direction, that is, the divided region 18 is connected to a corresponding one of the plurality of battery cells 1 of the cell block 12B. Therefore, in the bus bar 11, two corresponding battery cells 1 belonging to different cell blocks 12A and 12B are connected by each of the plurality of extending plate parts 15.

With the above-described configuration, in the battery module 10, a plurality of inter-block connection portions 21 each of which connects two corresponding battery cells 1 belonging to different cell blocks 12A and 12B, are formed in the bus bar 11. In the bus bar 11, the same number of the inter-block connection portions 21 as the parallel number of the battery cells 1 in each of the cell blocks 12 are formed. In the bus bar 11, each of the plurality of extending plate parts 15 constitutes a corresponding one of the inter-block connection portions 21, and the same number of inter-block connection portions 21 as that of the extending plate parts 15 are formed.

In the battery module 10, one or more intra-block connection portions 22 each of which connects two corresponding battery cells 1 belonging to the same cell block 12 are formed by the bus bar 11 for each of two cell blocks 12A and 12B. That is, the bus bar 11 forms one or more intra-block connection portions 22A each of which connects two corresponding battery cells 1 belonging to the cell block 12A to each other, and forms one or more intra-block connection portions 22B each of which connects two corresponding battery cells 1 belonging to the cell block 12B to each other. The bus bar 11 forms, for each of two cell blocks 12A and 12B, the intra-block connection portions 22 of the number which is obtained by subtracting 1 from the parallel number of the battery cells 1 in each of the cell blocks 12.

In the bus bar 11, each of the intra-block connection portions (first intra-block connection portions) 22A is constituted by divided regions 17 of two corresponding ones of the plurality of extending plate parts 15 and a bridge plate part 16 bridged between the two corresponding ones of the extending plate parts 15. In the bus bar 11, each of the intra-block connection portions (second intra-block connection portions) 22B is constituted by divided regions 18 of two corresponding ones of the plurality of extending plate parts 15 and a bridge plate part 16 bridged between the two corresponding ones of the extending plate parts 15.

In an example of FIG. 4 and the like, in the cell block (first cell block) 12A, two battery cells 1A and 1B are connected in a two-parallel manner, and in the cell block (second cell block) 12B, two battery cells 1C and 1D are connected in a two-parallel manner. Two inter-block connection portions 21A and 21B are formed in the bus bar 11. The inter-block connection portion (first inter-block connection portion) 21A is constituted by the extending plate part 15A, and connects the battery cell (first battery cell) 1A of the cell block 12A and the battery cell (third battery cell) 1C of the cell block 12B. The inter-block connection portion (second inter-block connection portion) 21B is constituted by the extending plate part 15B, and connects the battery cell (second battery cell) 1B of the cell block 12A and the battery cell (fourth battery cell) 1D of the cell block 12B.

In an example of FIG. 4 and the like, the bus bar 11 forms an intra-block connection portion 22A for the cell block 12A, and forms an intra-block connection portion 22B for the cell block 12B. The intra-block connection portion 22A is constituted by a divided region 17 of the extending plate parts 15A and 15B and a bridge plate part 16 bridged between the extending plate parts 15A and 15B. The intra-block connection portion 22A connects the battery cell (first battery cell) 1A and the battery cell (second battery cell) 1B of the cell block 12A. The intra-block connection portion 22B is constituted by a divided region 18 of the extending plate parts 15A and 15B and a bridge plate part 16 bridged between the extending plate parts 15A and 15B. The intra-block connection portion 22B connects the battery cell (third battery cell) 1C and the battery cell (fourth battery cell) 1D of the cell block 12B.

In the embodiments and the like, in the bus bar 11, the resistance of each of the intra-block connection portions 22 (22A, 22B) is higher than the resistance of any of the inter-block connection portions 21. In an example of FIGS. 3 and 4, the resistance of each of the intra-block connection portion 22A connecting the two battery cells 1A and 1B belonging to the cell block 12A and the intra-block connection portion 22B connecting the two battery cells 1C and 1D belonging to the cell block 12B is higher than the resistance of any of the inter-block connection portion 21A connecting the battery cell 1A of the cell block 12A and the battery cell 1C of the cell block 12B and the inter-block connection portion 21B connecting the battery cell 1B of the cell block 12A and the battery cell 1D of the cell block 12B.

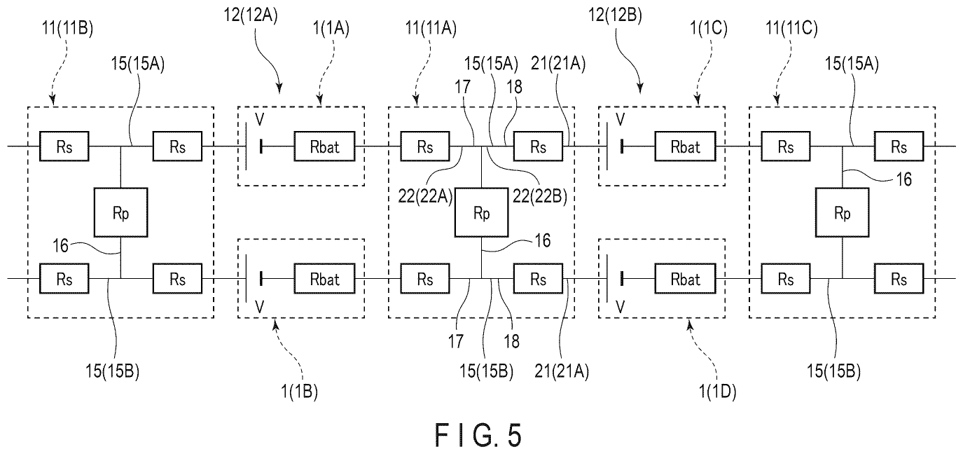

FIG. 5 is a schematic diagram showing an example of a circuit model of a battery module 10 according to embodiments and the like. An example of FIG. 5 shows an example in which battery cells 1 are connected in a two-parallel manner in each of the cell blocks 12 as in an example of FIGS. 2 and 4. As shown in FIG. 5 and the like, in each of the battery cells 1, a battery voltage V and internal resistance Rbat are defined. In an example, each of the battery cells 1 includes lithium titanate as a negative electrode active material. In each of the battery cells 1, the battery voltage V is about 2.6 V, and the internal resistance Rbat is about 1 mΩ.

In each of the bus bars 11, the resistance Rs of each of the divided regions 17 and 18 in each of the extending plate parts 15 and the resistance Rp of each of the bridge plate parts 16 are defined. Therefore, in the bus bar 11, the resistance of each of the plurality of inter-block connection portions 21 has a resistance value 2 Rs. In the bus bar 11, the resistance of each of the one or more intra-block connection portions 22A for the cell block 12A and the one or more intra-block connection portions 22B for the cell block 12B has a resistance value 2 Rs+Rp. In the embodiments and the like, the resistance of each of the intra-block connection portions 22A and 22B is higher than the resistance of any of the inter-block connection portions 21. That is, the relationship of the following Expression (1) is established.

$$\frac{2 Rs + Rp}{2 Rs} > 1 \qquad ( 1 )$$

Here, in a state where the battery module 10 is operated by charging and discharging the battery module 10 or the like, one of the plurality of battery cells 1 may rise to an excessively high temperature due to thermal runaway or the like. In this case, in the battery cell 1 in which thermal runaway or the like has occurred, any of the positive electrode and the negative electrode and the like comes into contact with the exterior container 3 or the lid member 5 due to the melting of the insulating member, or the like, and a short circuit occurs. As a result, in the battery cell 1 in which a short circuit occurs due to thermal runaway or the like, the battery voltage V is not generated, and a short circuit current flows between the battery cell 1 in which the short circuit occurs and the battery cell 1 electrically connected in parallel to the battery cell 1. That is, a short circuit current flows between the battery cell 1 in which the short circuit has occurred and other battery cells 1 belonging to the same cell block 12 as that of the battery cell 1.

In the battery module 10, in a case where a short-circuit current flows in the cell block 12 to which the battery cell 1 in which thermal runaway or the like has occurred belongs, it is required to quickly cut off the short-circuit current and to suppress a time during which the short-circuit current flows in a short time. Even in a case where thermal runaway occurs in a certain battery cell 1, Joule heat due to the short circuit current is suppressed to be small by suppressing the time during which the above-described short circuit current flows in a short time. As a result, in the cell blocks 12 other than the cell block 12 to which the battery cell 1 in which the thermal runaway has occurred belongs, an excessive temperature rise in the battery cell 1 is effectively suppressed. Therefore, by suppressing the time during which the short-circuit current flows in the cell block 12 to which the battery cell 1 in which the thermal runaway or the like has occurred belongs in a short time, the catching fire of other battery cells 1 due to the thermal runaway or the like in a battery cell 1 is effectively suppressed.

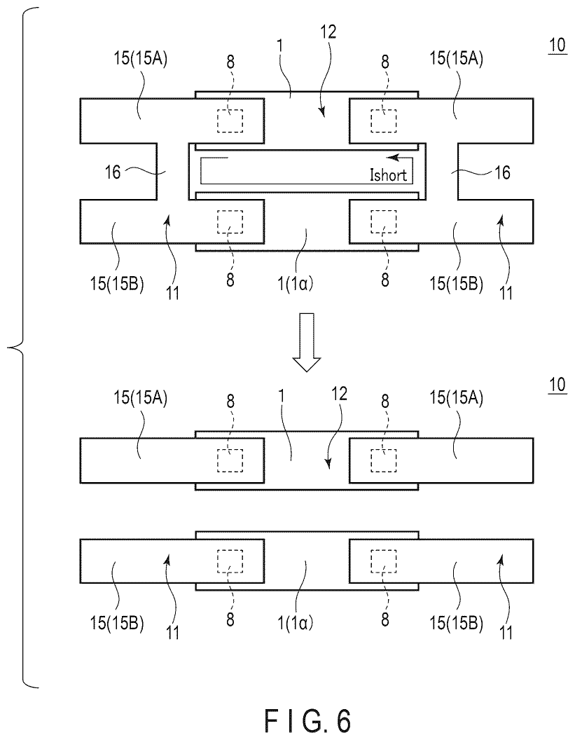

FIG. 6 is a schematic diagram showing an example of a situation change in a case where thermal runaway occurs in a certain battery cell 1 in a battery module 10 according to embodiments and the like. In an example of FIG. 6, an example in which battery cells 1 are connected in a two-parallel manner in each of the cell blocks 12 is shown. In an example of FIG. 6, the battery cell 1 in which the thermal runaway has occurred is also referred to as “battery cell 1α”. As shown in FIG. 6 and the like, in a case where the thermal runaway occurs in the battery cell 1α, a short circuit current Ishort flows between the battery cell 1α and the battery cell 1 connected in parallel to the battery cell 1α.

Here, in the embodiments and the like, in each of the bus bars 11, the resistance of each of the intra-block connection portions 22 is higher than the resistance of any of the inter-block connection portions 21. Therefore, in a case where a short circuit current flows in the cell block 12 to which the battery cell 1α belongs, the intra-block connection portion 22 melts in a short time in each of the bus bars 11 that electrically connect the cell block 12 to which the battery cell 1α belongs and other cell blocks 12. As a result, in the cell block 12 to which the battery cell 1α belongs, the short circuit current is cut off, and the time during which the short circuit current flows is suppressed in a short time.

In the present embodiment, in each of the bus bars 11, the plate width W2 of each of the bridge plate parts 16 is smaller than the plate width W1 of any of the extending plate parts 15, and the resistance per unit length of each of the bridge plate parts 16 is higher than the resistance per unit length of any of the extending plate parts 15. Therefore, even in a case where a short circuit current flows in the cell block 12 to which the battery cell 1α belongs due to the thermal runaway or the like of the battery cell 1α, the bridge plate parts 16 melts in a short time in any of the bus bars 11 that electrically connect the cell block 12 to which the battery cell 1α belongs and other cell blocks 12, as shown in FIG. 6 and the like. As a result, in the cell block 12 to which the battery cell 1α belongs, the short circuit current is appropriately cut off in a short time, and the time during which the short circuit current flows is appropriately suppressed in a short time.

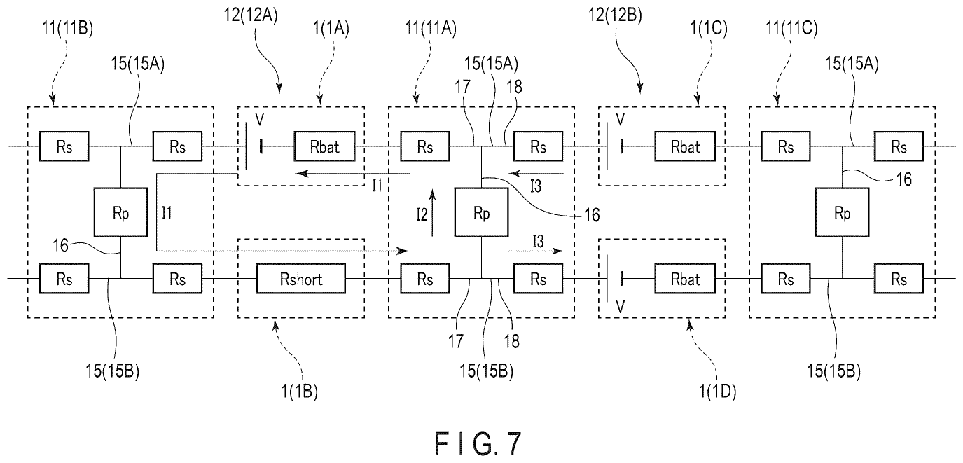

Here, in the configuration in which battery cells 1 are connected in a two-parallel manner in each of the plurality of cell blocks 12, a preferred example of the bus bar 11 that connects the battery cells 1 of the two cell blocks 12A and 12B will be described. FIG. 7 is a schematic diagram showing an example of a circuit model in a case where thermal runaway occurs in a certain battery cell 1 in a battery module 10 according to embodiments and the like. In an example of FIG. 7 and the like, the cell block (first cell block) 12A in which two battery cells 1A and 1B are connected in a two-parallel manner, and the cell block (second cell block) 12B in which two battery cells 1C and 1D are connected in a two-parallel manner are electrically connected by a bus bar 11. In an example of FIG. 7, a state where thermal runaway occurs in the battery cell 1B of the cell block 12A, and the battery voltage V is not generated in the battery cell 1B is shown.

In the following description, a bus bar 11 connecting the cell blocks 12A and 12B is also referred to as a “bus bar 11A”. The bus bar 11 different from the bus bar 11A connected to the cell block 12A is also referred to as a “bus bar 11B”, and the bus bar 11 different from the bus bar 11A connected to the cell block 12B is also referred to as a “bus bar 11C”. In an example of FIG. 7, the bus bar 11A is connected to the negative electrode terminals of the battery cells 1A and 1B of the cell block 12A and the positive electrode terminals of the battery cells 1C and 1D of the cell block 12B. The bus bar 11B is connected to the positive electrode terminals of the battery cells 1A and 1B of the cell block 12A and the bus bar 11C is connected to the negative electrode terminals of the battery cells 1C and ID of the cell block 12B. In the battery cell 1B in which the battery voltage V is not generated, the internal resistance Rshort is defined instead of the internal resistance Rbat. In an example, in the battery cell 1 in which the battery voltage Vis not generated, the internal resistance Rshort is about 1 mΩ.

As shown in FIG. 7, in a case where a short circuit occurs in the battery cell 1B due to thermal runaway and the like, the above-described short circuit current flows between the battery cell 1B and the battery cell 1A connected in parallel to the battery cell 1B, and the short circuit current flows in the cell block 12A to which battery cell 1B belongs. In a situation where the short-circuit current flows in the cell block 12A, a current I1 flows from the battery cell 1A through the bus bar 11B, the battery cell 1B in which the thermal runaway has occurred, and the divided region 17 of the extending plate part 15B of the bus bar 11A in this order. In the extending plate part 15B of the bus bar 11A, the current I1 is divided into a current I2 which flows through the bridge plate part 16 of the bus bar 11A, and a current I3 which passes through the divided region 18 of the extending plate part 15B of the bus bar 11A and flows through the battery cells 1C and 1D, and the bus bar 11C and the like. In the extending plate part 15A of the bus bar 11A, the current I2 from the bridge plate part 16 of the bus bar 11A and the current I3 from the divided region 18 of the extending plate part 15A of the bus bar 11A merge, and the current I1 in which the currents I2 and I3 merge flows toward the battery cell 1A through the divided region 17 of the extending plate part 15A of the bus bar 11A.

Here, using the battery voltage V and the internal resistance Rbat of each of the battery cells 1, the resistances Rs and Rp defined in each of the bus bars 11, and the internal resistance Rshort in the battery cell 1 in which the battery voltage Vis not generated, the current I1 is calculated as shown in Expression (2). The current I2 is calculated as shown in Expression (3) using the above-described parameters and the current I1, and the current I3 is calculated as shown in Expression (4) using the above-described parameters and the current I1. In a state where a short-circuit current flows through the cell block 12A as in an example of FIG. 7, a calorific value Win due to Joule heat at the bridge plate part 16 of the bus bar 11A is expressed as shown in Expression (5).

$$I 1 = V {( Rp + 4 Rs + Rbat + Rshort + \frac{Rp}{2} ( \frac{Rp + 4 Rs + 2 Rbat}{Rp + 2 Rs + Rbat} ) )}^{- 1} \qquad ( 2 )$$

$$I 2 = \frac{1}{2} \frac{Rp + 4 Rs + 2 Rbat}{Rp + 2 Rs + Rbat} I 1 \qquad ( 3 )$$

$$I 3 = \frac{1}{2} \frac{Rp}{Rp + 2 Rs + Rbat} I 1 \qquad ( 4 )$$

$$Win = Rp I {2}^{2} \qquad ( 5 )$$

In a case where the rate of temperature rise dT/dt of the bridge plate part 16 of the bus bar 11A in a state where a short-circuit current flows through the cell block 12A is defined, the rate of temperature rise dT/dt is calculated as shown in Expression (6) using a heat release amount Wout at the bridge plate part 16 and the heat capacity C of the bridge plate part 16 in addition to the calorific value Win calculated by Expression (5). The calorific value Win and the heat release amount Wout are indicated in units of W and the like, for example, and the heat capacity Cis indicated in units of J/K and the like, for example.

The heat release amount Wout at the bridge plate part 16 is calculated as shown in Expression (7) using a heat transfer coefficient h between the bus bar 11 and the atmosphere, the temperature Tbus of the bridge plate part 16 of the bus bar 11A, an environmental temperature Tatm at which the battery module 10 is used, and the surface area Asurf of the bridge plate part 16 of the bus bar 11. The heat capacity C of the bridge plate part 16 is calculated as shown in Expression (8) using the specific heat γ of the bus bar 11 (bridge plate part 16), the volume Vp of the bridge plate part 16, and the density ρ of the bus bar 11 (bridge plate part 16). Each of the surface area Asurf and the volume Vp of the bridge plate part 16 is calculated using the plate length L2, the plate width W2, and the plate thickness D2 of the bridge plate part 16 described above.

$$\frac{dT}{dt} = \frac{Win - Wout}{C} \qquad ( 6 )$$

$$Wout = h ( Tbus - Tatm ) Asurf \qquad ( 7 )$$

$$C = γ \cdot Vp \cdot ρ \qquad ( 8 )$$

Here, as in an example of FIG. 7 and the like, in a configuration in which battery cells 1 are connected in a two-parallel manner in each of the plurality of cell blocks 12, a simulation was performed on a situation where thermal runaway has occurred in a battery cell 1α. As a result of the simulation, in a case where the short-circuit current due to the thermal runaway flowed for 50 seconds in the cell block 12 to which the battery cell 1α belonged, the catching fire of the battery cell 1 occurred in the cell blocks 12 other than the cell block 12 to which the battery cell 1α in which the thermal runaway occurred belonged. Meanwhile, in a case where the time during which the short-circuit current due to the thermal runaway flowed was suppressed within 10 seconds in the cell block 12 to which the battery cell 1α belonged, the catching fire of the battery cell 1 did not occur in the cell blocks 12 other than the cell block 12 to which the battery cell 1α in which the thermal runaway has occurred belonged.

From the results of the above simulation, regarding the resistance component in the bus bar 11, a condition that the short-circuit current due to the thermal runaway was cut off within 10 seconds, that is, a condition that the bridge plate part 16 melted within 10 seconds after the short-circuit current flowed was calculated. At this time, a condition that a temperature 10 seconds after the short circuit current flowed was equal to or higher than the melting temperature (melting point) Tth of the bridge plate part 16 (bus bar 11) was calculated. The temperature 10 seconds after the short-circuit current flowed was calculated by calculating the rate of temperature rise dT/dt of the bridge plate part 16 using the above-described Expressions (2), (3), and (5) to (8) and the like. The calculation was performed assuming that the temperature of the bridge plate part 16 at the time when the short circuit current started to flow was 25° C.

In the calculation of the condition that the short-circuit current was cut off within 10 seconds, it was assumed that the bus bar 11 was formed of aluminum, and, in regard to the bus bar 11 (bridge plate part 16), the electrical conductivity was set to 38 mΩ⁻¹·mm⁻¹, the specific heat γ was set to 900 J·kg^{31 1}·K⁻¹, and the density ρ was set to 2.7 g·cm⁻³. In regard to the bus bar 11, the calculation was performed with the melting temperature Tth set to 660° C. and the plate thickness (the plate thickness D2 of the bridge plate part 16) set to 1 mm. In the calculation of the condition that the short-circuit current was cut off within 10 seconds, the heat transfer coefficient h between the bus bar 11 and the atmosphere was set to 5 W·m⁻²·K⁻¹, which was the physical property value of air in a state where no flow occurred. For each of the battery cells 1, the calculation was performed with the battery voltage V set to 2.6 V, the internal resistance Rbat set to 1 mΩ, and the internal resistance Rshort set to 1 mΩ for the battery cell 1 in which the battery voltage V was not generated.

As a result of the above-described calculation, in the bus bar 11, the fact that the resistance value 2Rs+Rp of resistance of each of the intra-block connection portions 22 was 1.2 times or more of the resistance value 2Rs of resistance of each of the inter-block connection portions 21 was calculated as a condition that the short-circuit current was cut off within 10 seconds. That is, in the configuration in which the battery cells 1 were connected in a two-parallel manner in each of the plurality of cell blocks 12, a condition represented by Expression (9) was calculated as the condition that the short-circuit current was cut off within 10 seconds. In a case where the resistance of each of the intra-block connection portions 22 is 1.2 times or more of the resistance of each of the inter-block connection portions 21, Joule heat is generated in the bridge plate part 16 to such an extent that the bridge plate part 16 melts within 10 seconds after the short circuit current flows.

$$\frac{2 Rs + Rp}{2 Rs} ≧ 1.2 \qquad ( 9 )$$

In a case where the short-circuit current flows in the cell block 12A to which the battery cell 1B in which the thermal runaway has occurred belongs, in addition to the short-circuit current being cut off in a short time, it is necessary to reduce the short-circuit current flowing in the cell block 12 connected in series to the cell block 12A. That is, in an example of FIG. 7, it is necessary to reduce the current I3 flowing through the battery cells 1C and 1D and the like. For example, it is necessary to reduce the current I3 to such an extent that the current I3 is 1/10 or less of the current I2 flowing through the bridge plate part 16 of the bus bar 11A.

From such a viewpoint, in the configuration in which battery cells 1 were connected in a two-parallel manner in each of the plurality of cell blocks 12, in addition to the above-described condition that the short-circuit current was cut off within 10 seconds, the condition that the current I3 is 1/10 or less of the current I2 (condition satisfying I3≤0.1×I2) is calculated. At this time, the condition that the current I3 was 1/10 or less of the current I2 was calculated using the above-described Expressions (2) to (4) and the like. The battery voltage V and the internal resistance Rbat of each of the battery cells 1, and the internal resistance Rshort of the battery cell 1 in which the battery voltage V was not generated, and the like were calculated as values similar to the calculation of the condition that the short-circuit current was cut off within 10 seconds.

As a result of the above-described calculation, in the bus bar 11, the fact that the resistance value 2Rs+Rp of resistance of each of the intra-block connection portions 22 was 4.2 times or less of the resistance value 2Rs of resistance of each of the inter-block connection portions 21 was calculated as the condition that the current I3 was 1/10 or less of the current I2. That is, in the configuration in which battery cells 1 are connected in a two-parallel manner in each of the plurality of cell blocks I2, a condition represented by Expression (10) was calculated as the condition that the current I3 was 1/10 or less of the current I2. In a case where the resistance of each of the intra-block connection portions 22 is 4.2 times or less of the resistance of each of the inter-block connection portions 21, the flowing short-circuit current is appropriately reduced in the cell block 12 connected in series to the cell block 12 to which the battery cell 1 in which the thermal runaway has occurred belongs.

$$\frac{2 Rs + Rp}{2 Rs} ≦ 4.2 \qquad ( 10 )$$

As described above, in the configuration in which two cell blocks 12 are connected in series by a bus bar 11 and battery cells 1 are connected in a two-parallel manner in each of the two cell blocks 12, the resistance of each of the intra-block connection portions 22 is preferably 1.2 times or more and 4.2 times or less of the resistance of each of the inter-block connection portions 21.

Since the resistance of each of the intra-block connection portions 22 is 1.2 times or less of the resistance of each of the inter-block connection portions 21, the time during which the short circuit current flows is appropriately suppressed in a short time even in a case where the short circuit current flows in the cell block 12 to which the battery cell 1 in which the thermal runaway has occurred belongs. As a result, the catching fire of the battery cell 1 other than the battery cell 1 in which the thermal runaway or the like has occurred is appropriately suppressed. In a case where the resistance of each of the intra-block connection portions 22 is 4.2 times or less of the resistance of each of the inter-block connection portions 21, the flowing short-circuit current is reduced in the cell block 12 connected in series to the cell block 12 to which the battery cell 1 in which the thermal runaway has occurred belongs.

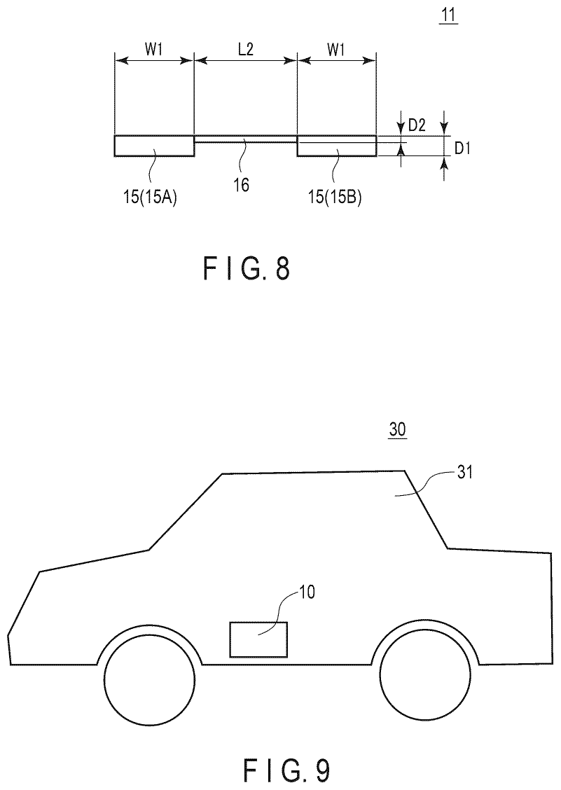

In the above-described embodiments and the like, in the bus bar 11, the plate width W2 of each of the bridge plate parts 16 is smaller than the plate width W1 of any of the extending plate parts 15, so that the resistance per unit length of each of the bridge plate parts 16 is higher than the resistance per unit length of any of the extending plate parts 15. FIG. 8 is a schematic diagram showing an example of the configuration of any one of bus bars 11 used in a battery module 10 in a certain modification according to embodiments and the like. As shown in FIG. 8, also in the present modification, similarly to the above-described embodiments and the like, a plurality of extending plate parts 15 and one or more bridge plate parts 16 are provided in the bus bar 11. In an example of FIG. 8, similarly to an example of FIGS. 3 and 4, two extending plate parts 15A and 15B and a bridge plate part 16 are provided.

Also in the present modification, as in the above-described embodiments and the like, directions and dimensions and the like are defined in each of the extending plate part 15 and the bridge plate part 16. In the bus bar 11, as in the above-described embodiments and the like, the plate length direction of each of the extending plate parts 15 coincides or substantially coincides with the plate width direction of each of the bridge plate parts 16, and the plate width direction of each of the extending plate parts 15 coincides or substantially coincides with the plate length direction of each of the bridge plate parts 16. The plate thickness direction of each of the extending plate parts 15 coincides with or substantially coincides with the plate thickness direction of each of the bridge plate parts 16. In FIG. 8, each of the extending plate parts 15 is shown as viewed from one side in the plate length direction, and the bridge plate part 16 is shown as viewed from one side in the plate width direction.

However, in the bus bar 11 of the present modification, unlike the above-described embodiments and the like, the plate thickness D2 of each of the bridge plate parts 16 is smaller (thinner) than the plate thickness D1 of any of the extending plate parts 15. In the bus bar 11 of the present modification, the plate width W1 of the extending plate part 15 and the plate width W2 of the bridge plate part 16 coincide or substantially coincide with each other. By such a configuration, also in the present modification, in the bus bar 11, the cross-sectional area of each of the bridge plate parts 16 is smaller than the cross-sectional area of any of the extending plate parts 15, and the resistance per unit length of each of the bridge plate parts 16 is higher than the resistance per unit length of any of the extending plate parts 15.

Also in the bus bar 11 of the present modification, as described above, the resistance per unit length of each of the bridge plate parts 16 is higher than the resistance per unit length of any of the extending plate parts 15. Therefore, even in a case where a short circuit current flows in the cell block 12 to which a certain battery cell 1α belongs due to the thermal runaway or the like of the battery cell 1α, the bridge plate parts 16 melts in a short time in any of the bus bars 11 that electrically connect the cell block 12 to which the battery cell 1α belongs and other cell blocks 12. As a result, also in the present modification, in the cell block 12 to which the battery cell 1α belongs, the short circuit current is appropriately cut off in a short time, and the time during which the short circuit current flows is appropriately suppressed in a short time.

In the bus bar 11 of a certain modification, the plate thickness D2 of each of the bridge plate parts 16 is smaller than the plate thickness D1 of any of the extending plate parts 15, and the plate width W2 of each of the bridge plate parts 16 is smaller than the plate width W1 of any of the extending plate parts 15. Also in this case, in the bus bar 11, the cross-sectional area of each of the bridge plate parts 16 is smaller than the cross-sectional area of any of the extending plate parts 15, and the resistance per unit length of each of the bridge plate parts 16 is higher than the resistance per unit length of any of the extending plate parts 15. Therefore, the present modification also exhibits the same operations and effects as those of the above-described embodiments and the like.

### (Battery-Mounted Device)

The battery module 10 described above is mounted on a battery-mounted device and used. Examples of the battery-mounted device on which the battery module 10 is mounted include a vehicle, a large power storage device for a power system, a smartphone, a stationary power supply device, a robot, and a drone. Examples of the vehicle serving as the battery-mounted device include an electric vehicle, a railway vehicle, an electric bus, a plug-in hybrid vehicle, and an electric motorcycle.

FIG. 9 is a schematic diagram showing an example of a vehicle 30 using a battery module 10 according to embodiments and the like. As shown in FIG. 9, the vehicle 30 serving as the battery-mounted device includes a vehicle body 31. The battery module 10 is mounted on the vehicle body 31. In addition to the battery module 10, a drive circuit, a control circuit, a power supply, and a load and the like (all not illustrated) are mounted on the vehicle body 31. The battery module 10 is charged with power from any of a power source mounted on the vehicle body 31, and a charger (not illustrated) outside the vehicle 30, and the like. At this time, after any of AC/DC conversion and transformation and the like is performed in the drive circuit, DC power in a voltage range corresponding to the battery module 10 is input from the drive circuit to the battery module 10. Examples of the power source mounted on the vehicle body 31 include a charger mounted on the vehicle, and a storage battery different from the battery module 10.

The power discharged from the battery module 10 is supplied to any of a load mounted on the vehicle body 31 and a device outside the vehicle 30, and the like. Examples of the load mounted on the vehicle body 31 include an electric motor that drives the vehicle 30 to travel. The DC power discharged from the battery module 10 is converted into power corresponding to a load and a device and the like in the drive circuit, and then supplied to the load and the device and the like. The control circuit includes any of a processor and an integrated circuit and the like mounted on the vehicle body 31. The control circuit controls the charging and discharging of the battery module 10 by, for example, controlling the driving of the drive circuit.

In at least one embodiment or example described above, in each of the two cell blocks connected in series to each other, the plurality of battery cells are connected in parallel to each other. The bus bar forms one or more intra-block connection portions each of which connects two corresponding battery cells belonging to a same cell block to each other for each of the two cell blocks, and forms a plurality of inter-block connection portions each of which connects two corresponding battery cells belonging to different cell blocks to each other. In the bus bar, the resistance of each of the intra-block connection portions is higher than the resistance of any of the inter-block connection portions. This makes it possible to provide a battery module, a vehicle, and a bus bar capable of effectively suppressing the catching fire of other battery cells even in a case where thermal runaway or the like occurs in one of the plurality of battery cells electrically connected to each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery module comprising:
two cell blocks each of which includes a plurality of battery cells electrically connected in parallel to each other, the two cell blocks being electrically connected in series to each other; and
a bus bar integrally formed of a conductive material and connecting the battery cells of the two cell blocks to each other, the bus bar forming one or more intra-block connection portions each of which connects two corresponding battery cells belonging to a same cell block for each of the two cell blocks, and forming a plurality of inter-block connection portions each of which connects two corresponding battery cells belonging to different cell blocks, resistance of each of the intra-block connection portions being higher than resistance of any of the inter-block connection portions.

2. The battery module according to claim 1, wherein the battery module includes,
as the two cell blocks, a first cell block including a first battery cell and a second battery cell as the battery cells, and a second cell block including a third battery cell and a fourth battery cell as the battery cells, wherein
the bus bar forms, as the intra-block connection portions, a first intra-block connection portion that connects the first battery cell and the second battery cell, and a second intra-block connection portion that connects the third battery cell and the fourth battery cell, and as the inter-block connection portions, a first inter-block connection portion that connects the first battery cell and the third battery cell, and a second inter-block connection portion that connects the second battery cell and the fourth battery cell,
resistance of each of the first intra-block connection portion and the second intra-block connection portion is 1.2 times or more and 4.2 times or less of resistance of each of the first inter-block connection portion and the second inter-block connection portion.

3. The battery module according to claim 1, wherein the bus bar includes:
a plurality of extending plate parts each of which connects corresponding two battery cells belonging to different cell blocks and constitutes a corresponding one of the inter-block connection portions; and
one or more bridge plate parts each of which is bridged between corresponding two of the extending plate parts and has a plate width smaller than a plate width of any of the extending plate parts.

4. The battery module according to claim 1, wherein the bus bar includes:
a plurality of extending plate parts each of which connects corresponding two battery cells belonging to different cell blocks and constitutes a corresponding one of the inter-block connection portions; and
one or more bridge plate portions each of which is bridged between corresponding two of the extending plate parts and has a plate thickness smaller than a plate thickness of any of the extending plate parts.

5. A vehicle comprising:
the battery module according to claim 1; and
a vehicle body on which the battery module is mounted.

6. A bus bar that connects a plurality of batteries of two cell blocks to each other in a battery module, the battery module including the two cell blocks each of which includes the batteries electrically connected in parallel to each other, the two cell blocks being electrically connected in series to each other, wherein
the bus bar is integrally formed of a conductive material,
the bus bar forms one or more intra-block connection portions each of which connects two corresponding battery cells belonging to a same cell block for each of the two cell blocks,
the bus bar forms a plurality of inter-block connection portions each of which connects two corresponding battery cells belonging to different cell blocks, and
resistance of each of the intra-block connection portions is higher than resistance of any of the inter-block connection portions.
